(19) United States
(12) Patent Application Publication
(10) Pub. No.: US 2026/0019219 A1
(43) Pub. Date: Jan. 15, 2026

(54) LONG TRAINING FIELD (LTF) FOR A DISTRIBUTED RESOURCE UNIT (DRU)

(71) Applicant: InterDigital Patent Holdings, Inc., Wilmington, DE (US)

(72) Inventors: Mahmoud Saad, Montreal (CA); Mrugen Deshmukh, Raleigh, NC (US); Ying Wang, Easton, PA (US); Hanqing Lou, Syosset, NY (US); Rui Yang, Greenlawn, NY (US)

(73) Assignee: InterDigital Patent Holdings, Inc., Wilmington, DE (US)

(21) Appl. No.: 18/771,544

(22) Filed: Jul. 12, 2024

(51) Int. Cl. H04L 5/00

(52) U.S. Cl. CPC H04L 5/0094; H04L 5/0053; H04L 5/0064

(57) ABSTRACT

A non-access point (AP) station (STA) receives a trigger frame with a resource unit (RU) allocation field. Further, the RU allocation field indicates a distributed resource unit (DRU) index value, and the STA determines, based on the indicated DRU index value, a DRU allocation from a plurality of DRU allocations. Each of the plurality of DRU allocations includes a respective tone distribution plan. Tones of the determined DRU allocation and the respective tone distribution plan are interleaved with tones of one or more other tone distribution plans, of the plurality of tone distribution plans, across a distribution bandwidth. The STA determines a DRU long training field (LTF) sequence. The STA transmits a signal in the determined DRU allocation, including a physical layer (PHY) preamble including the DRU LTF. Further, each respective value of the DRU LTF sequence is transmitted on a respective subcarrier of the determined DRU allocation.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

The traffic between STAs within a BSS may be considered as or referred to as peer-to-peer traffic. The peer-to-peer traffic may be sent between, for example, directly between, the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP; and the STAs, for example, all of the STAs, within or using the IBSS may communicate directly with each other. The IBSS mode of communication may sometimes be referred to herein as an “ad-hoc” mode of communication.

Using the 802.11ac infrastructure mode of operation, the AP may transmit a beacon on a fixed channel, usually the primary channel. This channel may be 20 megahertz (MHz) wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit any given time, frequency, and space resources in each BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHZ, 80 MHZ, and 160 MHz wide channels. The 40 MHZ, and 80 MHZ, channels are formed by combining contiguous 20 MHz channels similar to 802.11n described above. A 160 MHz channel may be formed either by combining 8 contiguous 20 MHz channels, or by combining two non-contiguous 80 MHz channels, which may also be referred to as an 80+80 configuration.

### SUMMARY

In an example, an Access Point (AP) transmits a trigger frame with a resource unit (RU) allocation field to a non-AP station (STA). The non-AP STA receives the trigger frame with the RU allocation field. Further, the RU allocation field indicates a distributed resource unit (DRU) index value, and the STA determines, based on the indicated DRU index value, a DRU allocation from a plurality of DRU allocations. Each of the plurality of DRU allocations includes a respective tone distribution plan. Further, tones of the determined DRU allocation and the respective tone distribution plan are interleaved with tones of one or more other tone distribution plans, of the plurality of tone distribution plans, across a distribution bandwidth.

The STA further determines a DRU long training field (LTF) sequence. Moreover, the STA transmits a signal, to the AP, in the determined DRU allocation, including a physical layer (PHY) preamble including the DRU LTF. Further, each respective value of the DRU LTF sequence is transmitted on a respective subcarrier of the determined DRU allocation.

Additionally or alternatively, the STA determines the DRU LTF based on a subset of values of an extremely high throughput (EHT)-LTF sequence. Further, each respective value of the DRU LTF sequence at a respective subcarrier index is the same as a respective value of the EHT-LTF at the respective subcarrier index. Additionally or alternatively, the subset of values of the EHT-LTF is associated with the determined distribution bandwidth.

Additionally or alternatively, the STA determines the DRU LTF based on a contiguous subset of values of an extremely EHT-LTF sequence. Additionally or alternatively, the contiguous subset of values is associated with a regular resource unit (RRU) corresponding to the DRU. Further, one or more other DRU LTFs include a respective plurality of other contiguous subsets of values of the ETH-LTF sequence corresponding to other RRUs.

Additionally or alternatively, the DRU index value is received in a User Info field in the trigger frame. Additionally or alternatively, the DRU-LTF is determined on a condition of receiving a value in an LTF Method subfield. Additionally or alternatively, the DRU-LTF is an Ultra High Reliability (UHR) LTF.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a system diagram illustrating an example Wi-Fi system;

FIG. 2B is a system diagram illustrating an example of indicating a particular distributed resource unit (DRU);

FIG. 3 is a frame format diagram illustrating an example of a high efficiency (HE) null data packet announcement (NDPA) frame format;

FIG. 4 is a field format diagram illustrating an example of a station (STA) Info field format in an extremely high throughput (EHT) NDPA frame;

FIG. 5A is a frame format diagram illustrating an example of an HE variant Common Info field format in a trigger frame;

FIG. 5B is a frame format diagram illustrating an example of an EHT variant Common Info field format in a trigger frame;

FIG. 5C is a frame format diagram illustrating an example of a Special User Info field;

FIG. 6 is a frame format diagram illustrating an example of an HE variant User Info field format and an EHT variant User Info field format in a trigger frame;

FIG. 7 is a transmission diagram illustrating a general example of a DRU over a distribution bandwidth;

FIG. 8 is a tone plan diagram illustrating an example of a tone plan for 26DRU20;

FIG. 9 is a tone plan diagram illustrating an example of a tone plan for 26DRU40;

FIG. 10 is a signaling diagram illustrating an example of using a long training field (LTF) for a DRU;

FIG. 11 is a subcarrier plan diagram illustrating an example of methods of determining values for an LTF sequence for a corresponding DRU;

FIG. 12 is an LTF diagram illustrating an example of methods of determining values for an LTF sequence for a corresponding DRU in a distribution bandwidth of 20 megahertz (MHZ);

FIG. 13 is a stem diagram illustrating an example of an application of a 1×LTF type to a 26DRU40;

FIG. 14 is a stem diagram illustrating an example of an application of a 2×LTF type to a 106DRU80;

FIG. 15 is a stem diagram illustrating an example of an application of a 4×LTF type to a 26DRU40;

FIG. 16 a resource diagram illustrating an example of combining smaller DRUs to form larger DRUs with the tones of the larger DRUs grouped; and

FIG. 17 is a peak-to-average-power ratio (PAPR) performance diagram illustrating an example of the PAPR performance of an LTF of a tone-grouped DRU, an LTF of a tone-ungrouped DRU, and an LTF of a regular resource unit (RRU).

### DETAILED DESCRIPTION

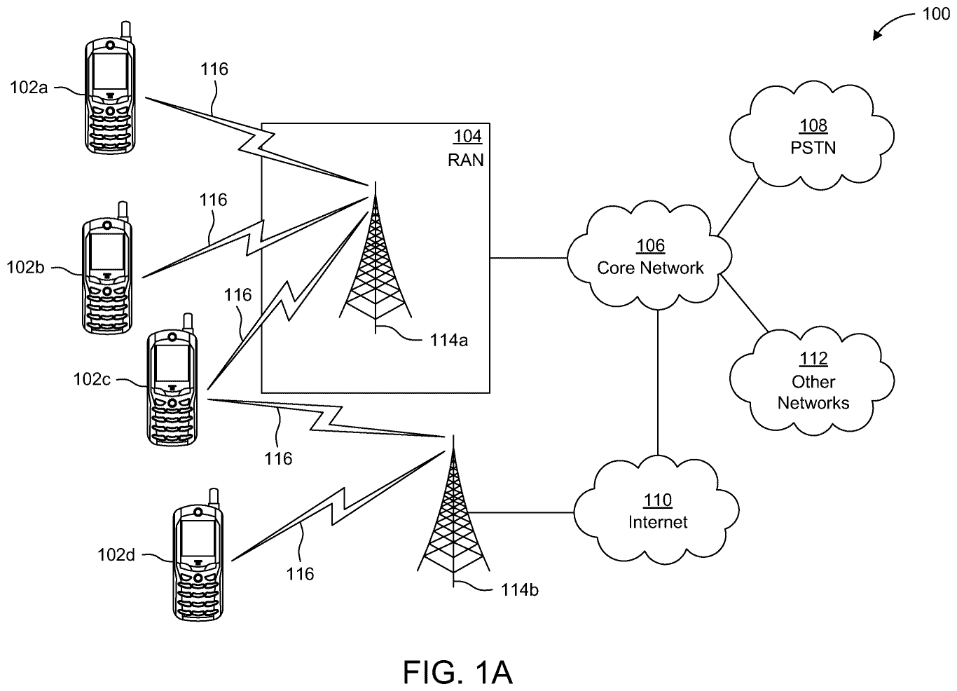

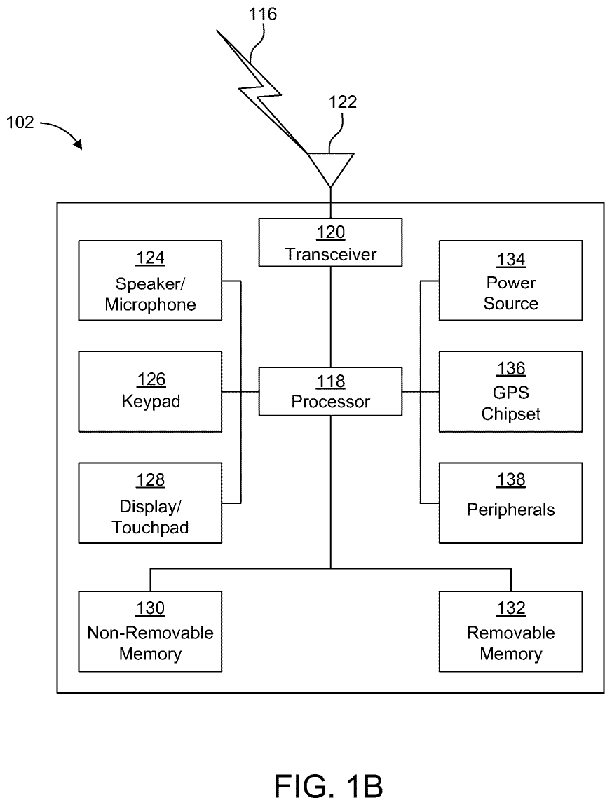

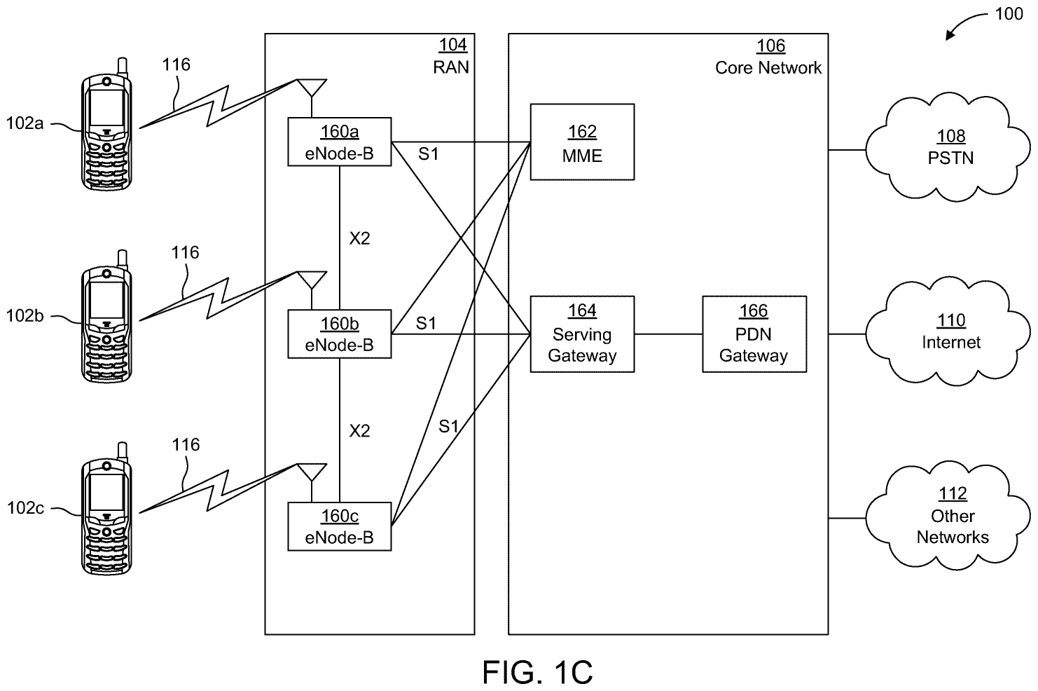

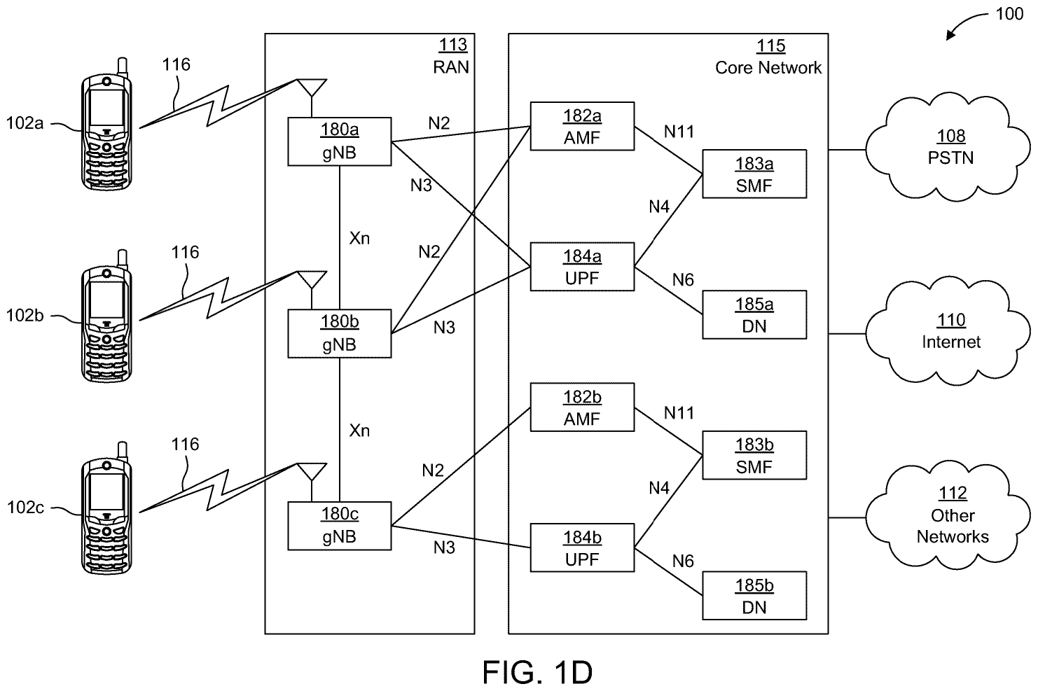

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHZ wide channel.

Very High Throughput (VHT or 802.11ac) STAs may support 20 MHz, 40 MHZ, 80 MHZ, and/or 160 MHZ wide channels transmitted over a 5 GHz frequency band using OFDMA. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHZ, 80 MHZ, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

For an 80+80 configuration, the data, after channel encoding, is passed through a segment parser that divides it into two streams. The Inverse Discrete Fourier Transformation (IDFT) operation and time-domain processing is done on each stream separately. The streams are then mapped on to the two channels, and the data is transmitted. At the receiver, this mechanism is reversed, and the combined data is sent to the MAC layer.

As noted above, in 802.11 ax, High Efficiency (HE) Wireless STAs may support 20 MHz, 40 MHZ, 80 MHZ, and/or 160 MHz wide channels capable of transmission over 2.4 GHZ, 5 GHZ, and 6 GHz frequency bands using both OFDMA and MU-MIMO capabilities. OFDMA subcarrier modulation in HE STAs includes formats such as BPSK, QPSK, 16-QAM, 64-QAM, 256-QAM, and 1024-QAM. The evolution of 802.11 to EHT or (802.11be) STAs extend to having 320 MHz wide channels.

Sub 1 GHz modes of operation are supported by 802.11af, and 802.11ah. For these specifications the channel operating bandwidths, and carriers, are reduced relative to those used in 802.11n, and 802.11ac. 802.11af supports 5 MHZ, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, 802.11ah, 802.11AX, and 802.11be, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g., MTC type devices) that only support a 1 MHz mode even if the AP, and other STAs in the BSS, may support a 2 MHZ, 4 MHZ, 8 MHZ, 16 MHZ, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

The IEEE 802.11 Ultra High Reliability (UHR) Study Group was formed explore the possibility to improve reliability, support further reduced low latency traffic, further increase peak throughput, improve power saving capabilities, and improve efficiency of the IEEE 802.11 network over HEW. A distributed-tone resource unit (DRU) may be used in UHR communications.

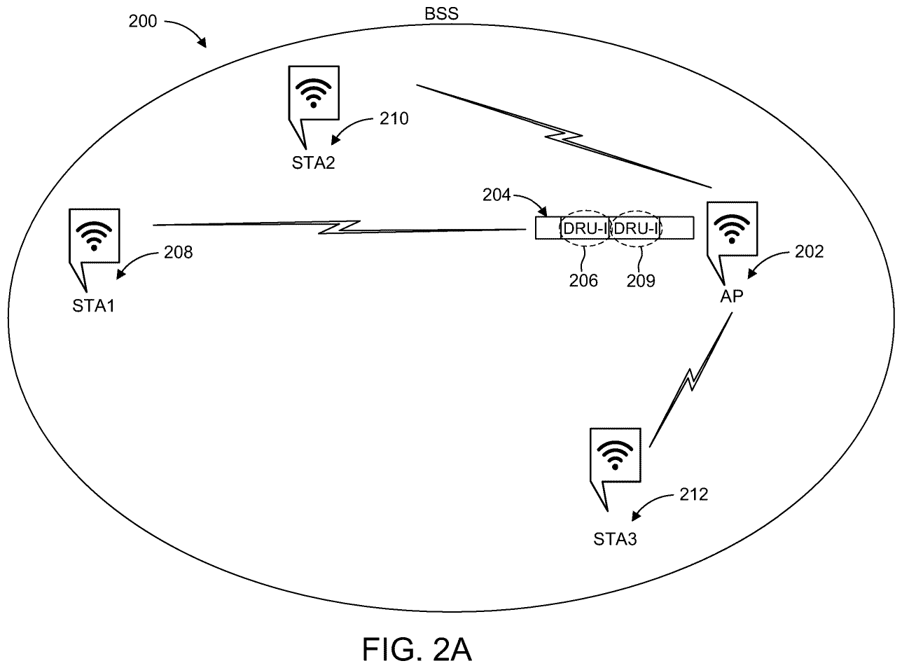

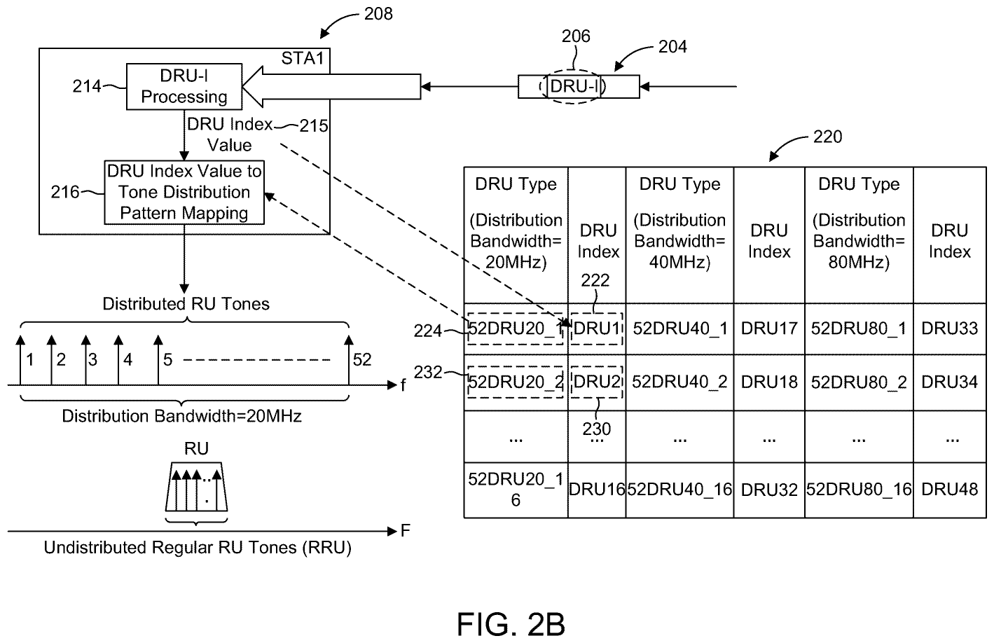

FIG. 2A is a system diagram illustrating an example Wi-Fi system. Examples shown in FIG. 2A include a Wi-Fi system, such as BSS 200, operable according to embodiments provided herein. In examples provided herein, channel sounding procedures are utilized to, among other things, determine channel state information (CSI) between an AP 202 and the STA1 208, STA2 210, STA3 212 of the BSS 200. In some instances, it may be appropriate for a STA to use a long training field (LTF) for a DRU, in procedures where, for example, communication between the STA and AP is adjusted based on the reception of the LTF. Additionally or alternatively, one or more of STAs 208, 210, 212 may be the same as or similar to WTRU 102. Additionally or alternatively, AP 202 may be the same as or similar to base station 114a, base station 114b, or both.

In an example, AP 202 may send information regarding a DRU to the STA1 208. The STA1 208 may determine a DRU based on the information regarding the DRU. Further, the STA1 208 may determine an LTF to use. The STA1 208 may then transmit the LTF to the AP 202 using the STA's DRU. Additionally or alternatively, information regarding the DRU may be sent in a trigger frame.

FIG. 2B is a system diagram illustrating an example of indicating a particular DRU. As shown in an example in FIG. 2B, STA1 208 receives a frame 204, including DRU information 206. Further, STA1 208 processes the received DRU information 206 at a DRU-I processing component 214 in order to extract either a DRU allocation index field, or both a DRU allocation index field and a distribution bandwidth field from the frame 204. In the illustrated example, a DRU index value 215 is obtained from the DRU allocation index field and sent to a mapping table 216 to indicate the particular DRU. For example, a mapping table such as table 220 may be incorporated within a DRU index to tone-distribution mapping component 216 to indicate a DRU by mapping a DRU index value to a DRU. For instance, based on obtaining a DRU index value of DRU1 222, table 220 can map the value DRU1 to a corresponding DRU such as 52DRU20_1 224, whereby 52DRU20_1 includes 52 subcarrier tones to be distributed over a 20 MHz bandwidth with tone distribution pattern 1. Additionally or alternatively, a mapping table may utilize both a distribution bandwidth value and a DRU index value to indicate a particular DRU.

Referring back to FIG. 2A, the AP 202 may also transmit frame 204 to STA2 210. Further, the AP's 202 transmitted frame 204 may also include DRU information 209 corresponding to STA2 210. Upon receiving the DRU information 209, the STA2 210 can also transmit its LTF to AP 202 using a DRU for STA 2 210. As depicted in FIG. 2B, for instance, based on obtaining a DRU index value of DRU2 230, table 220 can map the value DRU2 to a corresponding DRU such as 52DRU20_2 232, whereby 52DRU20_2 includes 52 subcarrier tones to be distributed over a 20 MHz bandwidth with tone distribution pattern 2. Further, tones of tone distribution pattern 2 may be interleaved in the frequency domain with tones of tone distribution pattern 1 for STA1. Additionally or alternatively, a mapping table may utilize both a distribution bandwidth value and a DRU index value to indicate a particular DRU.

Additionally or alternatively, when considering the values in the LTF sequence for the DRU of a STA, the LTF value used by a subcarrier of the DRU may be the same value as an EHT-LTF value for that subcarrier, in one method. In another method, a subset of the LTF values for the DRU may be the same value as a subset of consecutive values of an EHT-LTF, additionally or alternatively. Additionally or alternatively, based on receiving a frame, such as a trigger frame, by AP 202, the STA may be assigned to use one of these methods. Additionally or alternatively, based on receiving frame 204, STA 3 212 may be assigned, by AP 202, with a regular resource unit (RRU) as opposed to a DRU for its LTF.

An EHT transmission has a preamble that contains EHT-LTF symbols, where the data tones of each EHT-LTF symbol are multiplied by entries belonging to a matrix PEHT-LTF, to enable channel estimation at the receiver. The EHT-LTF field in the EHT preamble provides a means for the receiver to estimate the MIMO channel between the set of constellation mapper outputs and the receive chains.

In an EHT MU PPDU, NEHT-LTF is indicated in the EHT-SIG field. In a non-OFDMA EHT MU PPDU or EHT sounding null data packet (NDP), the initial number of EHT-LTF symbols, initial NEHT-LTF, is a function of the total number of spatial streams. In an EHT TB PPDU, NEHT-LTF is indicated in the Trigger frame that triggers the transmission of the PPDU.

An EHT PPDU supports three EHT-LTF types: 1× EHT-LTF with a duration of 3.2 μs, 2× EHT-LTF with a duration of 6.4 μs, and 4× EHT-LTF with a duration of 12.8 μs.

In a 20 MHz transmission, the 1× HE-LTF sequence transmitted on subcarriers [−122:122] is given by:

$${EHTLTF}_{- 122 , 122} = \{ 0 , 0 , - 1 , 0 , 0 , 0 , + 1 , 0 , 0 , 0 , + 1 , 0 , 0 , 0 , - 1 , 0 , 0 , 0 , + 1 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 , 0 \} .$$

In a 20 MHz transmission, the 2× HE-LTF sequence transmitted on subcarriers [−122:122] is given by:

$${EHTLTF}_{- 122 , 122} = \{ - 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , - 1 , 0 , - 1 , 0 , + 1 , 0 , + 1 , 0 , - 1 , 0 , + 1 , 0 , + 1 , 0 , + 1 , 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , + 1 , 0 , - 1 , 0 , - 1 , 0 , - 1 , 0 , + 1 , 0 , + 1 , 0 , + 1 , 0 , - 1 , 0 , - 1 , 0 , + 1 , 0 , 0 , 0 , + 1 , 0 , - 1 , 0 , + 1 , 0 , + 1 , 0 , - 1 , 0 , + 1 , 0 , + 1 , 0 , - 1 , 0 , + 1 , 0 , + 1 , 0 , - 1 , 0 , - 1 , 0 , + 1 , 0 , - 1 , 0 , + 1 , 0 , + 1 , 0 , + 1 , 0 , + 1 , 0 , - 1 , 0 , + 1 , 0 , - 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , + 1 , 0 , - 1 , 0 , + 1 , 0 , + 1 , 0 , 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , + 1 , 0 , - 1 , 0 , + 1 \} .$$

In a 20 MHz transmission, the 4× HE-LTF sequence transmitted on subcarriers [−122:122] is given by:

$${EHTLTF}_{- 122 , 122} = \{ - 1 , - 1 , + 1 , - 1 , + 1 , - 1 , + 1 , + 1 , + 1 , - 1 , + 1 , + 1 , + 1 , - 1 , - 1 , + 1 , - 1 , - 1 , - 1 , - 1 , - 1 , + 1 , + 1 , - 1 , - 1 , - 1 , - 1 , + 1 , + 1 , - 1 , + 1 , - 1 , + 1 , + 1 , + 1 , + 1 , - 1 , + 1 , - 1 , - 1 , + 1 , + 1 , - 1 , + 1 , + 1 , + 1 , + 1 , - 1 , - 1 , + 1 , - 1 , - 1 , - 1 , + 1 , + 1 , + 1 , + 1 , - 1 , + 1 , + 1 , - 1 , - 1 , - 1 , - 1 , + 1 , - 1 , - 1 , + 1 , + 1 , - 1 , + 1 , - 1 , - 1 , - 1 , - 1 , + 1 , - 1 , + 1 , - 1 , - 1 , - 1 , - 1 , - 1 , - 1 , + 1 , + 1 , - 1 , - 1 , - 1 , - 1 , - 1 , + 1 , - 1 , - 1 , + 1 , + 1 , + 1 , - 1 , + 1 , + 1 , + 1 , - 1 , + 1 , - 1 , + 1 , - 1 , - 1 , - 1 , - 1 , - 1 , + 1 , + 1 , + 1 , - 1 , - 1 , - 1 , + 1 , - 1 , + 1 , + 1 , + 1 , 0 , 0 , 0 , - 1 , + 1 , - 1 , + 1 , - 1 , + 1 , + 1 , - 1 , + 1 , + 1 , + 1 , - 1 , - 1 , + 1 , - 1 , - 1 , + 1 , - 1 , + 1 , - 1 , + 1 , + 1 , + 1 , - 1 , + 1 , + 1 , + 1 , - 1 , - 1 , + 1 , - 1 , - 1 , - 1 , - 1 , - 1 , + 1 , + 1 , - 1 , - 1 , - 1 , - 1 , - 1 , - 1 , + 1 , - 1 , + 1 , - 1 , - 1 , - 1 , - 1 , + 1 , - 1 , + 1 , + 1 , - 1 , - 1 , + 1 , - 1 , - 1 , - 1 , - 1 , + 1 , + 1 , - 1 , + 1 , + 1 , + 1 , + 1 , + 1 , + 1 , + 1 , - 1 , + 1 , + 1 , - 1 , - 1 , - 1 , - 1 , + 1 , - 1 , - 1 , + 1 , + 1 , - 1 , + 1 , - 1 , - 1 , - 1 , - 1 , + 1 , - 1 , + 1 , - 1 , - 1 , + 1 , + 1 , + 1 , + 1 , - 1 , - 1 , + 1 , + 1 , + 1 , + 1 , + 1 , - 1 , + 1 , + 1 , - 1 , - 1 , - 1 , + 1 , - 1 , - 1 , - 1 , + 1 , - 1 , + 1 , - 1 , + 1 , + 1 \} .$$

Wi-Fi communication may use an NDP announcement (NDPA). For example, in 802.11be communication, the structure of the NDPA may be similar to the NDPA of 802.11ax.

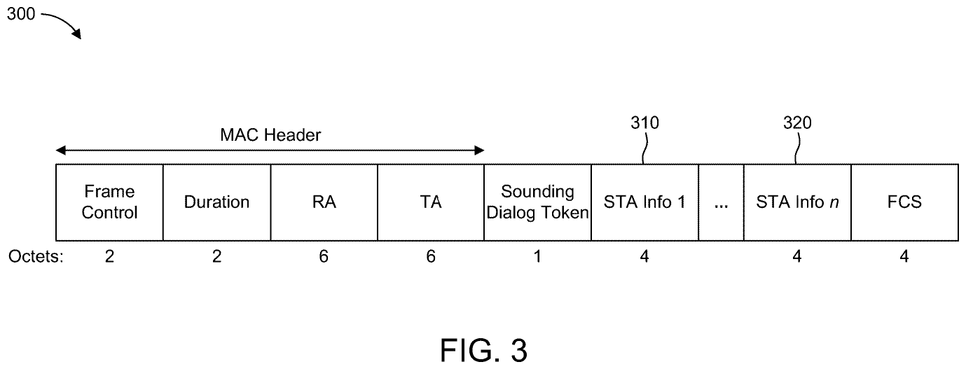

FIG. 3 is a frame format diagram illustrating an example of an HE NDPA frame format. As shown in frame format diagram 300, the NDPA frame format may include a STA Info 1 field 310 for a first STA, as well as other STA Info fields, up to and including a STA Info n field 320. The other STA Info fields may be for the first STA, in an example. Additionally or alternatively, the other STA Info fields may be for other STAs. For example, a STA Info 2 field, not shown, may be for a second STA. Further, the STA Info n field 320 may be for an nth STA. Example contents of a STA Info field are shown below.

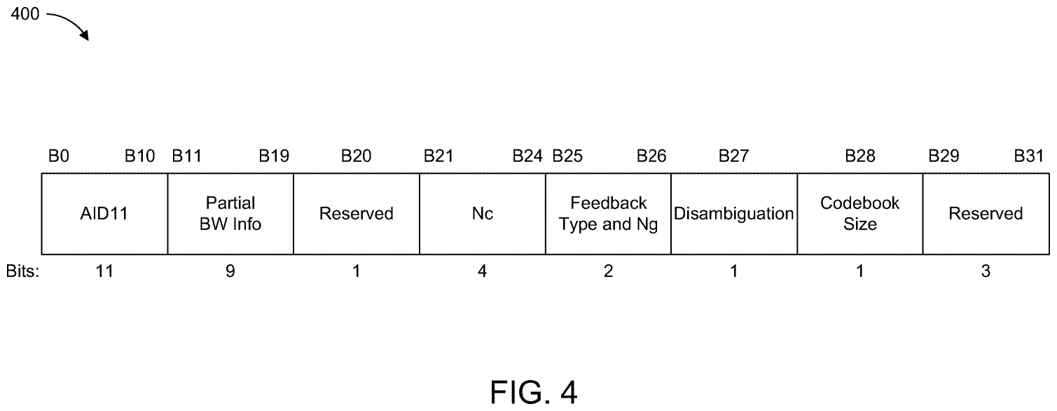

FIG. 4 is a field format diagram illustrating an example of a STA Info field format in an EHT NDPA frame. As shown in field format 400, the STA Info field format may include information for a STA. Additionally or alternatively, the STA Info field format may be changed to accommodate new features of UHR communication.

Trigger frame was introduced firstly in 802.11ax. EHT supports greater BW, multiple RU allocation, an enhanced modulation and coding scheme (MCS), and a greater number of spatial streams. 802.11be modified the trigger frame so that the trigger frame supports new features of 802.11be, and meanwhile the Trigger frame is backwards compatible with 802.11ax. The trigger frame is used to allocate resources, and trigger single user access or multi-user access. A trigger frame format defined in 802.11ax is shown in Table 1, below. 802.11be reuses the same format for the trigger frame.

TABLE 1
Trigger frame format in 802.11ax

| | Field: | | | | | | | | | |
|---|---|---|---|---|---|---|---|---|---|---|
| | Frame | | | | Common | User | | User | | |
| | Control | Duration | RA | TA | Info | Info | . . . | Info | Padding | FCS |
| Octets: | 2 | 2 | 6 | 6 | 8 or | 5 or | | 5 or | v | 4 |
| | | | | | more | more | | more | | |

The Common Info field in 802.11be has two variants, the HE variant and the EHT variant.

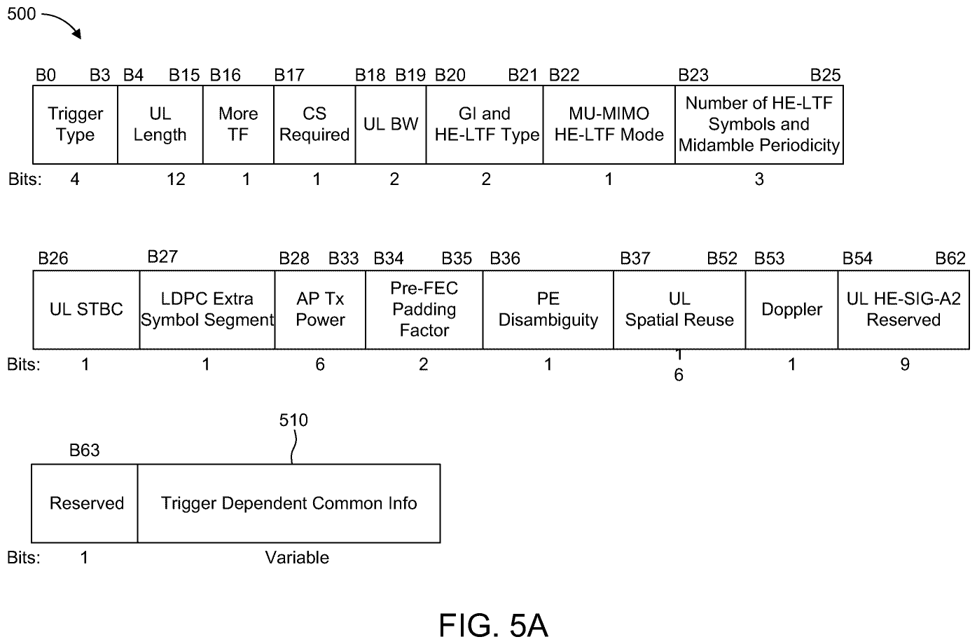

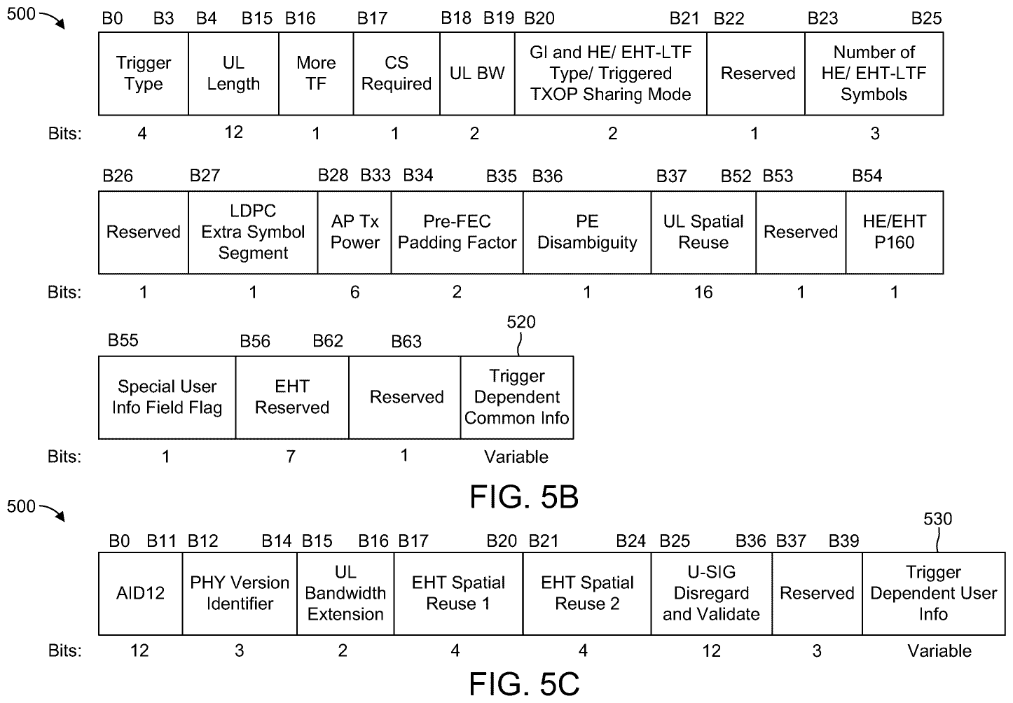

FIG. 5A is a frame format diagram illustrating an example of an HE variant Common Info field format in a trigger frame. As shown in an example in FIG. 5A, the Trigger Dependent Common Info subfield 510 may be of variable bit length. The bit lengths of the other subfields in the HE variant Common Info field format may be as shown in FIG. 5A.

FIG. 5B is a frame format diagram illustrating an example of an EHT variant Common Info field format in a trigger frame. As shown in an example in FIG. 5B, the Trigger Dependent Common Info subfield 520 may be of variable bit length. The bit lengths of the other subfields in the EHT variant Common Info field format may be as shown in FIG. 5B.

Further, there are three types of User Info fields defined in 802.11be: the Special User Info field, the HE variant User Info field and the EHT variant User Info field. The Special User Info field carries extended common information for EHT STAs to transmit a EHT TB-PPDU.

FIG. 5C is a frame format diagram illustrating an example of a Special User Info field. As shown in an example in FIG. 5C, the Trigger Dependent User Info subfield 530 may be of variable bit length. The bit lengths of the other subfields in the Special User Info field may be as shown in FIG. 5C.

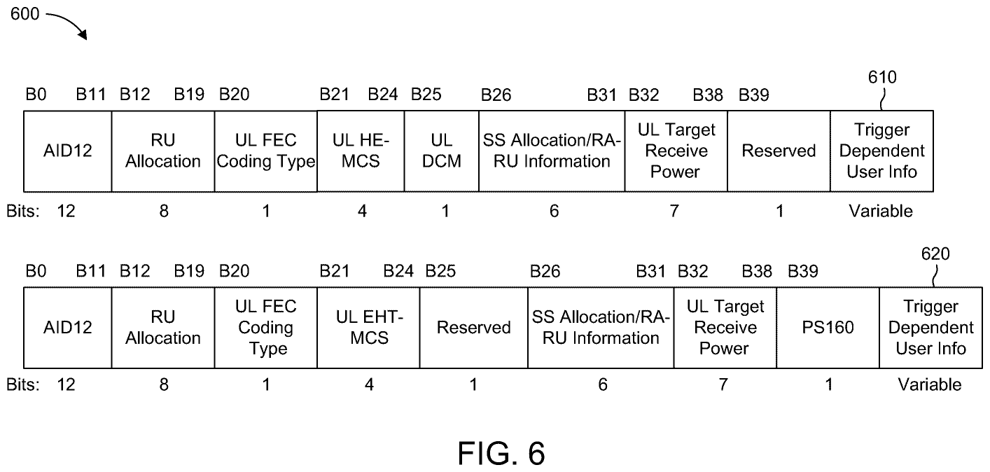

FIG. 6 is a frame format diagram illustrating an example of an HE variant User Info field format and an EHT variant Common Info field format in a trigger frame. The HE variant User Info field for all trigger types except Null Feedback Report Poll (NFRP) trigger is defined in the top part of FIG. 6. As shown in an example in FIG. 6, the Trigger Dependent User Info subfield 610 of the HE variant User Info field format may be of variable length. The bit lengths of the other subfields in the HE variant User Info field format may be as shown in FIG. 6.

Also, the EHT variant User Info field for all trigger types except NFRP trigger is defined in the bottom part of FIG. 6. As shown in an example in FIG. 6, the Trigger Dependent User Info subfield 620 of the EHT variant User Info field format may be of variable length. The bit lengths of the other subfields in the EHT variant User Info field format may be as shown in FIG. 6.

The trigger type subfield in Common Info field (such as in FIG. 5A or FIG. 5B), in the trigger frame format shown in Table 1, has possible values as shown in Table 2, below.

TABLE 2
Trigger Type

| Trigger Type | |
|---|---|
| Subfield value | Trigger frame variant |
| 0 | Basic |
| 1 | BF Report Poll (BFRP) |
| 2 | MU-BAR |
| 3 | MU-RTS |
| 4 | Buffer Status Report |
| | Poll (BSRP) |
| 5 | GCR MU-BAR |
| 6 | Bandwidth Query |
| | Report Poll (BQRP) |
| 7 | NDP Feedback Report |
| | Poll (NFRP) |
| 8 | Ranging/Sensing |
| 9-15 | Reserved |

In embodiments and examples provided herein, an RU may refer to one or more subcarriers used in DL and UL transmissions. Also, a tone may refer to one subcarrier used in DL or UL transmission. A DRU is a resource unit whose subcarriers are spread over a certain bandwidth which is larger than the effective bandwidth occupied by this resource unit. The effective bandwidth of an RU equals N×Δfₛ where N is the number of tones of the RU and Δfₛ is the subcarrier spacing. In WLAN, range extension can be achieved by distributing the tones of an RU over a wider bandwidth which allows for higher transmit power for each individual tone while at the same time conforming with the power spectral density (PSD) regulations. Further, a DRU may also be referred to as a tone distributed (TD) RU (TD-RU) or a distributed RU, and still be consistent with the embodiments and example provided herein.

Also, a distribution bandwidth may refer to a bandwidth in which the tones of a set of one or more DRUs are spread on. An RRU may refer to a resource unit whose subcarriers are contiguous as defined by 11ax and 11be amendments.

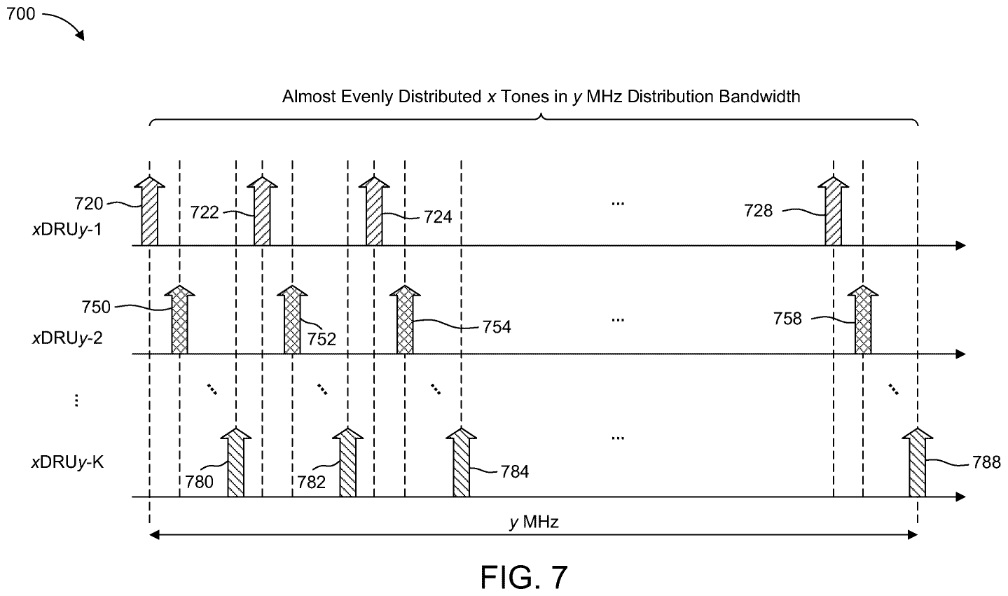

FIG. 7 is a transmission diagram illustrating a general example of a distributed-tone resource unit over a distribution bandwidth. As shown in an example in transmission diagram 700, a general x-tones DRU may be distributed over a y MHz distribution bandwidth, and may be denoted as xDRUy. In an example, a 26DRU20 is a 26-tone resource unit (effective bandwidth is ˜ 2 MHZ) with a DRU allocation spread over a distribution bandwidth of 20 MHz. In another example, a 106DRU80 is a 106-tone resource unit (effective bandwidth is ˜ 8 MHZ) with a DRU allocation spread over a distribution bandwidth of 80 MHz. A 20 MHz channel may include up to nine 26DRU20 DRU allocations, four 52DRU20 DRU allocations, or two 106DRU20 DRU allocations. For proper transmission, a channel bandwidth should accommodate the effective bandwidth of the DRUs as well as bandwidth needed for guard, null and DC subcarriers.

In an example shown in FIG. 7 for resource allocations for an xDRUy, a first DRU allocation for a first DRU type, such as xDRUy-1 may include a tone plan with tone distributed across subcarriers over a y MHz distribution bandwidth. For example, the tone plan for xDRUy-1 may include the transmission of tones 720, 722, 724, 728 over a first set of distributed subcarriers. The second DRU allocation for a second DRU type may include a tone plan for xDRUy-2. The tone plan for DRU allocation xDRUy-2 may transmit over a second set of distributed subcarriers adjacent to, but not overlapping with, the first set of distributed subcarriers. For example, the tone plan for DRU allocation xDRUy-2 may include the transmission of tones 750, 752, 754, 758 over the second set of distributed subcarriers. In order to ensure that the tones in tone plan for DRU allocation xDRUy-1 do not overlap with the tones in the tone plan for DRU allocation xDRUy-2, the spacing between the tones of the tone plan for DRU allocation xDRUy-1 will match the spacing between the tones of the tone plan for DRU allocation xDRUy-2, as shown in FIG. 7.

Further tone plans for the remaining DRU allocations for the remaining DRU types may include transmissions of tones over distributed subcarriers that do not overlap with the distributed subcarriers of the other tone plans. Similarly, the spacing between the tones within each of the tone plans will match for all DRU allocations for the DRU types of xDRUy, in order to ensure that the tones of one tone plan do not overlap with the tones of another. Moreover, the final DRU type, xDRUy-K will have a DRU allocation for its DRU type, including a tone plan with transmission of tones 780, 782, 784, 788 over another set of distributed subcarriers. In this way, the DRU allocations for the DRU types of xDRUy include almost evenly distributed x tones in the y MHz distribution bandwidth.

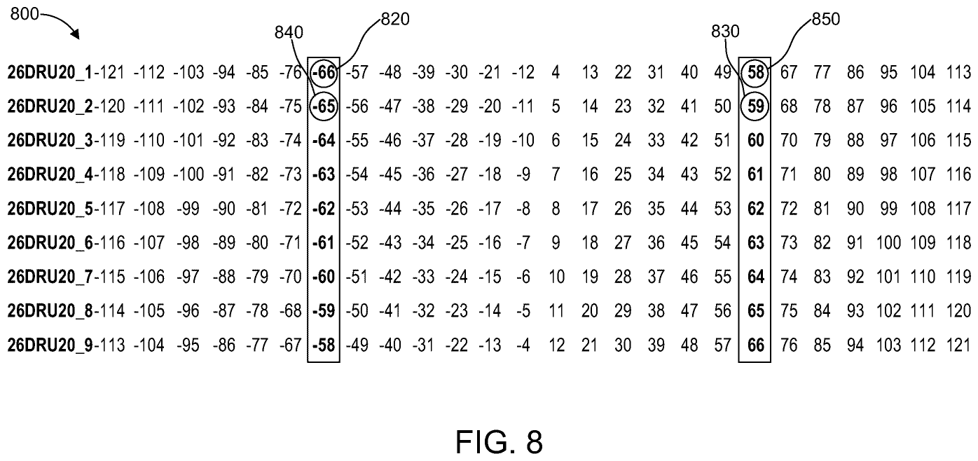

FIG. 8 is a tone plan diagram illustrating an example of a tone plan for 26DRU20. As shown in tone plan diagram 800, 26DRU20 may include one or more of the nine listed DRU allocations, 26DRU20_1 through 26DRU20_9. Further, the highlighted tones in the rectangular boxes are the pilot tones for each DRU allocation. For example, the pilot tones of DRU allocation 26DRU20_1 are at tone index {−66, 58} 820, 850 and the pilot tones of DRU allocation 26DRU20_2 are tone index {−65, 59} 840, 830.

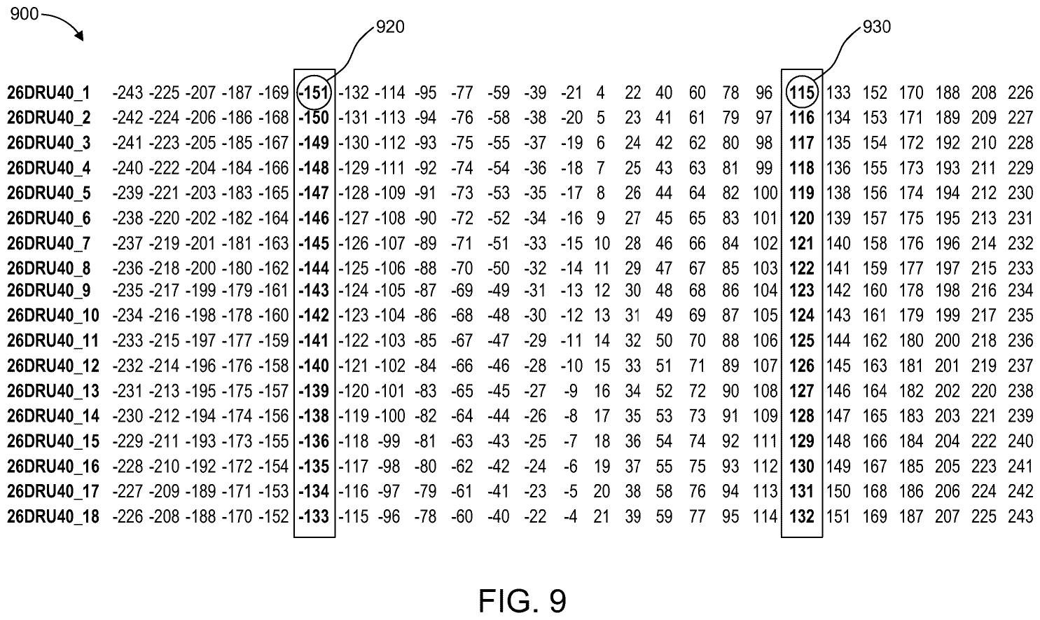

FIG. 9 is a tone plan diagram illustrating an example of a tone plan for 26DRU40. As shown in tone plan diagram 900, 26DRU40 may include one or more of the eighteen listed DRU allocations, 26DRU40_1 through 26DRU40_18. Further, the highlighted tones in the rectangular boxes are the pilot tones for each DRU allocation. For example, the pilot tones of DRU allocation 26DRU40_1 are tone index {−151, 115} 920, 930.

The design of an LTF to support a DRU in UHR is an open problem in wireless communications. Specifically, 802.11ax/be specified three LTF types, namely, 1×LTF, 2×LTF, and 4×LTF each with a different sequence in the frequency domain and a different duration in the time domain. All these types were proposed to suit the conventional RRU. The direct application of the current LTF types and sequences to a DRU may cause uneven distribution of the active LTF tones. This uneven distribution in turn causes two problems, the asymmetry of the LTF active tones around the direct current (DC) tone and the clustering of the active LTF tones in parts of the bandwidth, and may lead to a worsening peak-to-average power ratio (PAPR) performance.

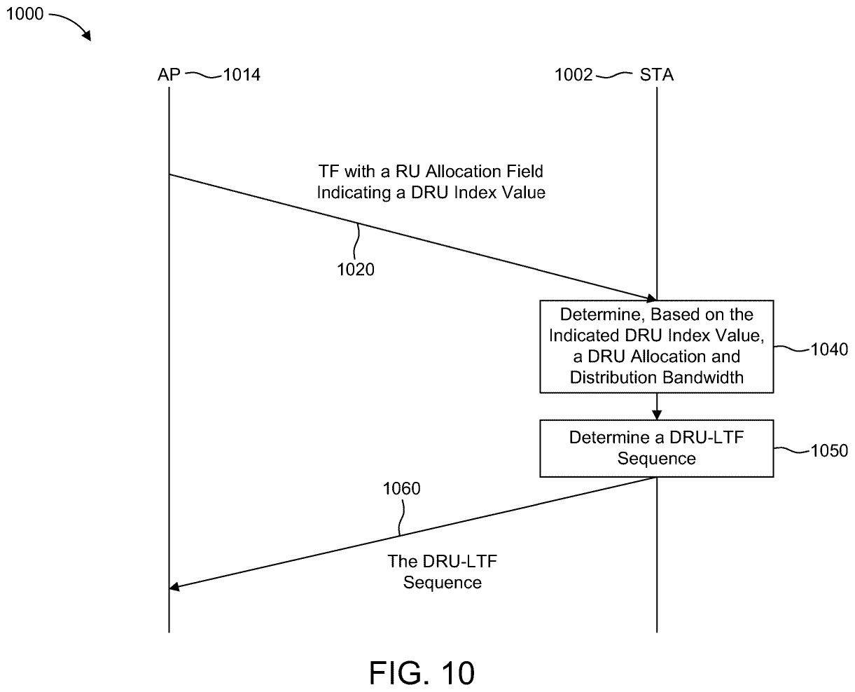

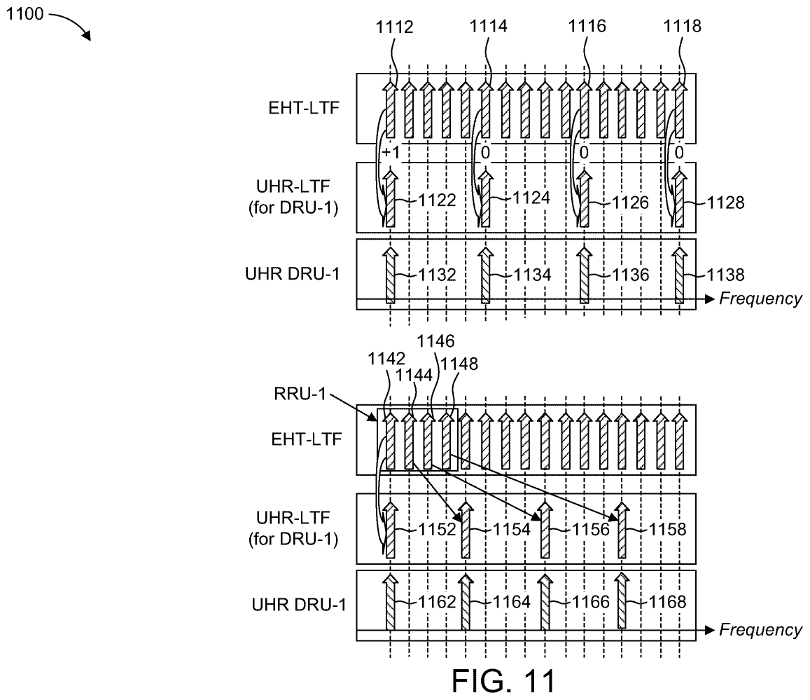

FIG. 10 is a signaling diagram illustrating an example of using an LTF for a DRU. As shown in an example in signaling diagram 1000, an AP 1014 transmits a trigger frame with an RU allocation field 1020 to a non-AP STA 1002. In an example, the AP 1014 may be the same as, or similar to, base station 114a in FIG. 1A. Further, the non-AP STA 1002 may be the same as, or similar to, WTRU 102a in FIG. 1A, WTRU 102 in FIG. 1B, or both, in examples. The RU allocation field includes indication information indicating a DRU index value 1020. Accordingly, the non-AP STA 1002 receives a trigger frame with an RU allocation field indicating the DRU index value, and the non-AP STA 1002 determines, based on the indicated DRU index value, a DRU allocation from a plurality of DRU allocations 1040. Each of the plurality of DRU allocations includes a respective tone distribution plan. Further, tones of the determined DRU allocation and the respective tone distribution plan are interleaved with tones of one or more other tone distribution plans, of the plurality of tone distribution plans, across a distribution bandwidth.

The non-AP STA 1002 further determines a DRU LTF sequence 1050. Moreover, the STA 1002 transmits a signal, to the AP 1014, in the determined DRU allocation, including a physical layer (PHY) preamble including the DRU LTF sequence 1060. Further, each respective value of the DRU LTF sequence is transmitted on a respective subcarrier of the determined DRU allocation.

In one method, the non-AP STA 1002 determines the DRU LTF sequence 1050 based on a subset of values of an EHT-LTF sequence. Further, each respective value of the DRU LTF sequence at a respective subcarrier index is the same as a respective value of the EHT-LTF at the respective subcarrier index. Additionally or alternatively, the subset of values of the EHT-LTF is associated with the determined distribution bandwidth.

In another method, the non-AP STA 1002 determines the DRU LTF sequence 1050 based on a contiguous subset of values of an EHT-LTF sequence. Additionally or alternatively, the contiguous subset of values of the EHT-LTF sequence is associated with an RRU corresponding to the DRU. Additionally or alternatively, one or more other DRU LTFs include a respective plurality of other contiguous subsets of values of the ETH-LTF sequence corresponding to other RRUs.

Additionally or alternatively, the DRU index value is received in a User Info field in the trigger frame. Additionally or alternatively, the DRU-LTF is a UHR-LTF. Additionally or alternatively, the method used by the non-AP STA 1002 to determine the DRU-LTF is based on a value in an LTF method subfield. For example, one value in the LTF method subfield may indicate one method, and another value may indicate the other method. The non-AP STA 1002 may receive the LTF method subfield from the AP 1014.

FIG. 11 is a subcarrier plan diagram illustrating an example of methods of determining values for an LTF sequence for a corresponding DRU. As shown in examples in subcarrier plan diagram 1100, there may be two methods to determine or design the LTF sequence of DRUs.

In a first example method, the values of an LTF sequence of a DRU may be picked from the existing set of values of an EHT-LTF sequence corresponding to the distribution bandwidth at the subcarrier indices of the DRU. The existing EHT-LTF sequence may be one of the 1× EHT-LTF, 2× EHT-LTF, or 4× EHT-LTF types. For example, if a DRU of size n has a distribution bandwidth of 20 MHz and occupies subcarrier indices {k₀, k₁, . . . , kₙ₋₁}, and the corresponding EHT-LTF sequence is given as EHTLTF_{-122,122}, then the values of the LTF sequence of this DRU is given by the subset of values {EHTLTF_{-122,122} (k₀), EHTLTF_{-122,122}(k₁), . . . , EHTLTF_{-122,122} (kₙ₋₁)} on subcarriers {k₀, k₁, . . . , kₙ₋₁}, and 0 on all other subcarriers. In an example with multiple DRUs for the first method, the subset of k subcarriers do not represent consecutive subcarriers of the EHT-LTF. Instead, the subset of k subcarriers are interleaved among other subcarriers in the EHT-LTF, and these other subcarriers may be used by other DRUs.

An example of the first method is shown in FIG. 11, where the values of the UHR-LTF sequence occupying subcarrier indices 1122, 1124, 1126, 1128 are given by the subset of values occupying subcarrier indices 1112, 1114, 1116, 1118 of the set of values in the EHT-LTF. In an example, the value of subcarrier index 1112 is +1 and this value is given to the same subcarrier index in the UHR-LTF 1122, while the value of subcarrier index 1114 is 0 and this value is given to the same subcarrier index 1124 in the UHR-LTF. Likewise, the value of subcarrier index 1116 is 0, and this value is given to the same subcarrier index 1126 in the UHR-LTF, and the value of subcarrier index 1118 is 0, and this value is given to the same subcarrier index 1128 in the UHR-LTF. This UHR-LTF sequence {+1, 0, 0, 0} may be for UHR DRU-1. Accordingly, a STA may transmit the UHR-LTF sequence {+1, 0, 0, 0} using UHR DRU-1 on subcarrier indices 1132, 1134, 1136, 1138, wherein the subcarrier index for 1132 is the same as 1122, the subcarrier index for 1134 is the same as 1124, the subcarrier index for 1136 is the same as 1126, and the subcarrier index for 1138 is the same as 1128.

Additionally or alternatively, in a second example method shown in FIG. 11, the LTF sequence of a DRU may reuse the LTF sequence of the corresponding RRU. The corresponding RRU to a DRU is the RRU with the same size and same indexing as the DRU in the same (distribution) bandwidth. For example, for a given bandwidth, say 20 MHz, there may be a set of nine 26-tone RRUs and also a set of nine 26-tone DRUs, each set indexed from 1 to 9. In an example, RRU 1 corresponds to DRU 1, RRU 2 to DRU 2, and so on. Specifically, in the second example method, the LTF sequence of the first RRU may be used for the first DRU, the LTF sequence of the second RRU may be used for the second DRU, and so on and so forth. For example, if a DRU of size n has a distribution bandwidth of 20 MHZ, occupying subcarriers {k₀, k₁, . . . , kₙ₋₁}, and it is the first DRU in the set of DRUs of the same size n corresponding to this distribution bandwidth, then the LTF sequence of this DRU is given by a contiguous subset {EHTLTF_{-122,122} (−122), EHTLTF_{-122,122} (−121), . . . , EHTLTF_{-122,122} (−122+n−1)} of values of the EHT-LTF. The first DRU may be used by a first STA, and the contiguous set of values is then transmitted by the first STA on subcarriers {k₀, k₁, . . . , kₙ₋₁} of the first DRU, and the first STA transmits 0 on all other subcarriers.

Additionally or alternatively, a second STA may use the second DRU with a second contiguous subset of values of the EHT-LTF. Likewise, a third STA may use the third DRU with a third contiguous subset of values of the EHT-LTF, and so forth.

An example of the second method is shown in FIG. 11, where the values of the UHR-LTF sequence occupying subcarrier indices 1152, 1154, 1156, 1158 are given by a contiguous subset of values occupying consecutive subcarrier indices 1142, 1144, 1146, 1148 of the set of values in the EHT-LTF. For example, if the value occupying subcarrier index 1142 is +1, this value is given to the subcarrier index in the UHR-LTF 1152. Similarly, if the value occupying subcarrier index 1144 is 0, this value is given to the subcarrier index 1154 in the UHR-LTF. In the second example method, subcarrier index 1154 is different in frequency from subcarrier index 1144. The values for subcarrier indices 1156, 1158 are given by subcarrier indices 1146, 1148 in like manner. Similarly, subcarrier indices 1156, 1158 are different in frequency from subcarrier indices 1146, 1148.

The UHR-LTF sequence may be for UHR DRU-1. Accordingly, a STA may transmit the UHR-LTF sequence using UHR DRU-1 on subcarrier indices 1162, 1164, 1166, 1168, wherein the subcarrier index for 1162 is the same as 1152, the subcarrier index for 1164 is the same as 1154, the subcarrier index for 1166 is the same as 1156, and the subcarrier index for 1168 is the same as 1158.

Additionally or alternatively, in a further example, a second STA may transmit a second LTF using a second UHR DRU, such as UHR DRU-2. The second LTF may be a second UHR-LTF which uses a second contiguous subset values from the EHT-LTF occupying second consecutive subcarrier indices which correspond to a second RRU, such as RRU-2. The second consecutive subcarrier indices in the EFT-LTF for RRU-2 may be different in frequency from the subcarrier indices in the EHT-LTF for RRU-1.

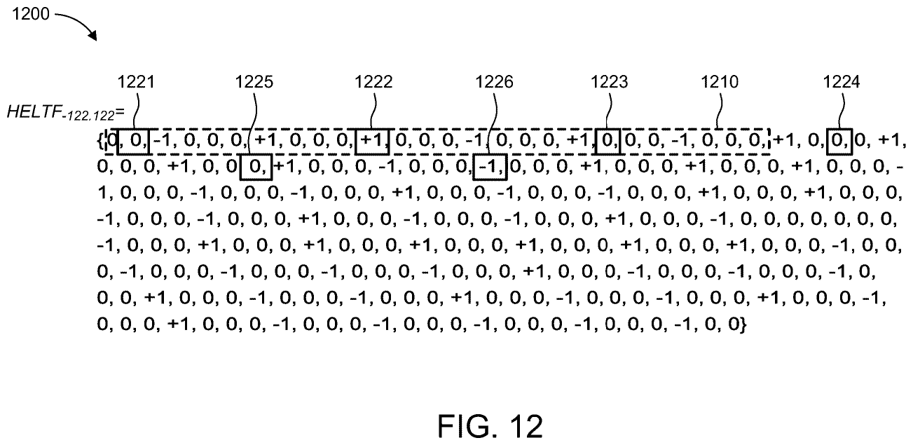

FIG. 12 is an LTF diagram illustrating an example of methods of determining values for an LTF sequence for a corresponding DRU in a distribution bandwidth of 20 MHz. As shown in LTF diagram 1200, a 26-tone DRU may be used in the 20 MHz distribution bandwidth.

In an example, the non-AP STA that is allocated a DRU to transmit in the uplink may pick the LTF sequence corresponding to the subcarrier indices of the allocated DRU. The non-AP STA may receive the trigger frame and decode the User Info field identified by its AID12 to learn the DRU index allocated to it. Further, the non-AP STA may pick the LTF sequence of the subcarrier indices corresponding to this DRU index. This behavior is an example of the first method, described above.

For example, the non-AP STA that is allocated a DRU may pick 26 values from the LTF sequence corresponding to the subcarrier indices of the allocated DRU. FIG. 12 includes an illustration of the picking of the first 6 values of these 26 values. For example, the non-AP STA that is allocated a DRU may pick 6 values from the LTF sequence corresponding to subcarrier indices 1121, 1222, 1223, 1224, 1225, 1226 of the allocated DRU. Accordingly, the first 6 values of the LTF for the DRU would then be {0, +1, 0, 0, 0, −1}. Another 20 values would then be chosen in like manner for the LTF of the allocated DRU, for a total of 26 values for the LTF. The non-AP STA would then transmit this LTF, with 26 values, on the subcarrier indices of the allocated DRU.

In another example, the non-AP STA that is allocated a DRU to use to transmit in the uplink may use the 26 values of LTF sequence 1210 of the RRU corresponding to the allocated DRU. The non-AP STA may receive the trigger frame and decode the User Info field identified by its AID12 to learn the DRU index allocated to it, and use the 26 value LTF sequence 1210 of the RRU index corresponding to this DRU index. This behavior is an example of the second method, described above.

In a further example, the AP may indicate in the Common Info field or the User Info field in the Trigger frame which method will be used to generate the LTF sequence for a given DRU based on the DRU Index and the LTF type. In one example, a subfield named LTF Method may be defined in the Common Info field or the User Info field such that a value 0 (or 1) may indicate that method 1 shall be used and a value 1 (or 0) may indicate that method 2 shall be used.

In an example, the direct application of the current LTF types, namely, 1×LTF and 2×LTF, using the first method may cause uneven distribution of the active LTF tones for a given DRU and may subsequently cause other problems, as described further in the following.

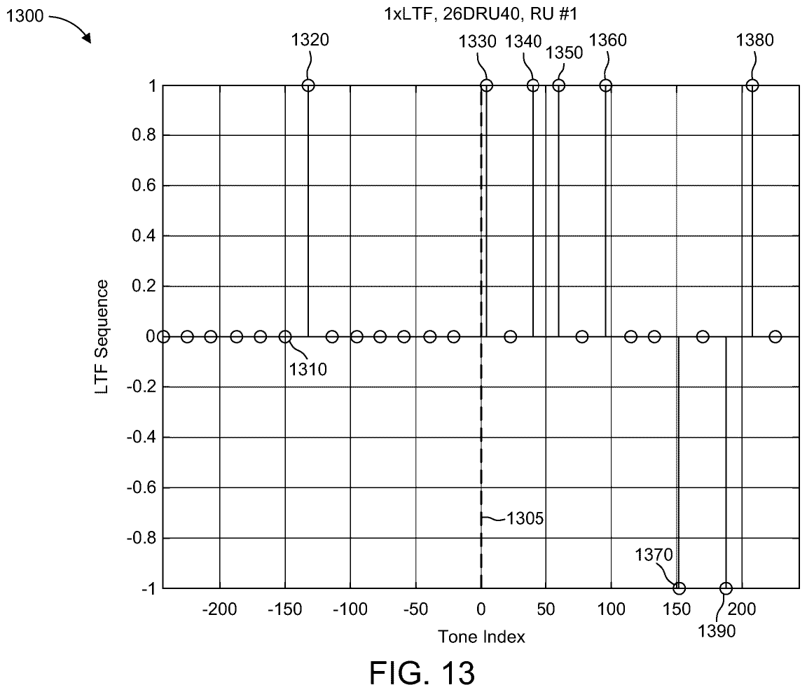

FIG. 13 is a stem diagram illustrating an example of an application of a 1×LTF type to a 26DRU40. As shown in an example in stem diagram 1300, the active LTF tones 1320, 1330, 1340, 1350, 1360, 1370, 1380, 1390 may have asymmetrical distribution around the DC tone 1305. Tone 1310 is an example of one of the several inactive tones shown in FIG. 13.

In one example, as illustrated in FIG. 13, when the 1×LTF type is applied to the 26DRU40, the resulting LTF sequence has only one active tone 1320 to the left of the DC tone and several active tones 1330, 1340, 1350, 1360, 1370, 1380, 1390 to the right of the DC tone 1305. In an example, the LTF sequence may be used in a first resource unit (RU), such as RU #1.

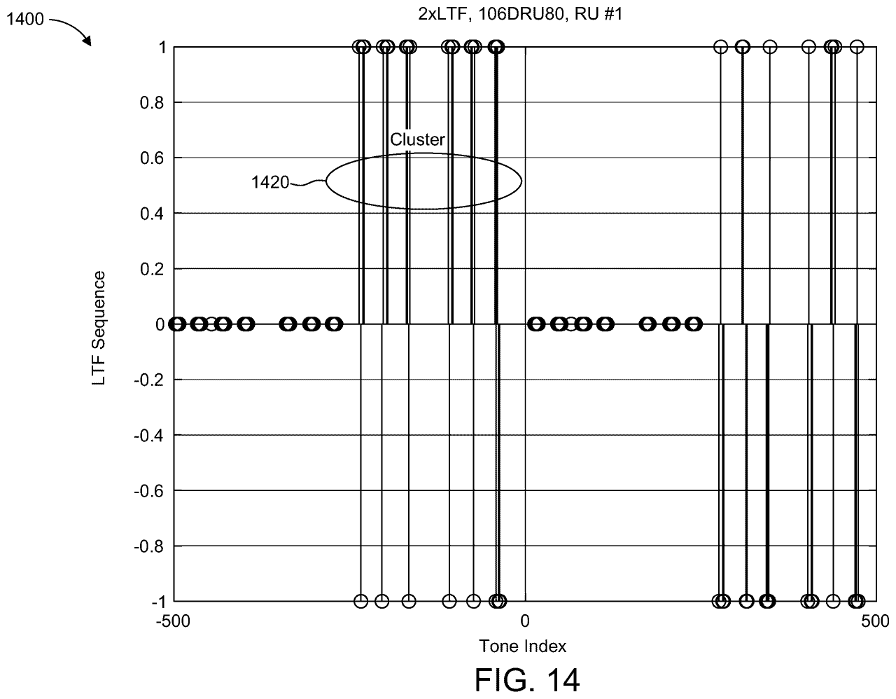

FIG. 14 is a stem diagram illustrating an example of an application of a 2×LTF type to a 106DRU80. As shown in an example in stem diagram 1400, the active LTF tones may get clustered in one part of the distribution bandwidth 1420. In one example, as illustrated in FIG. 14, when the 2×LTF type is applied to the 106DRU80, the resulting LTF sequence may have many active tones in a certain portion of the distribution bandwidth and no active tones in other portions of the distribution bandwidth.

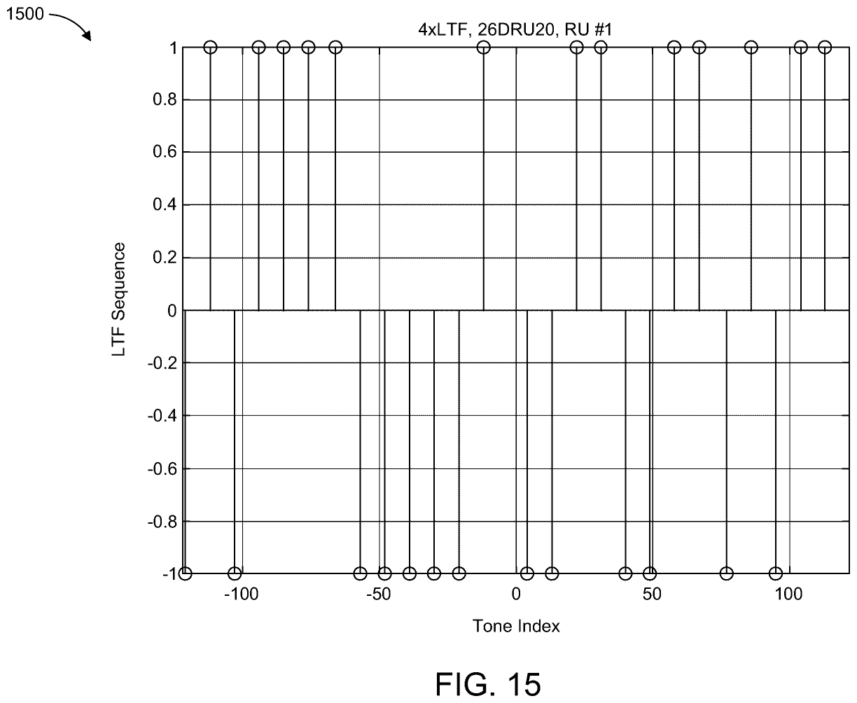

FIG. 15 is a stem diagram illustrating an example of an application of a 4×LTF type to a 26DRU40. As shown in an example in stem diagram 1500, applying the 4×LTF type to DRU may avoid the above-mentioned problems and may result in almost evenly distributed active LTF tones allowing for a better channel estimation of the DRU in the distribution bandwidth.

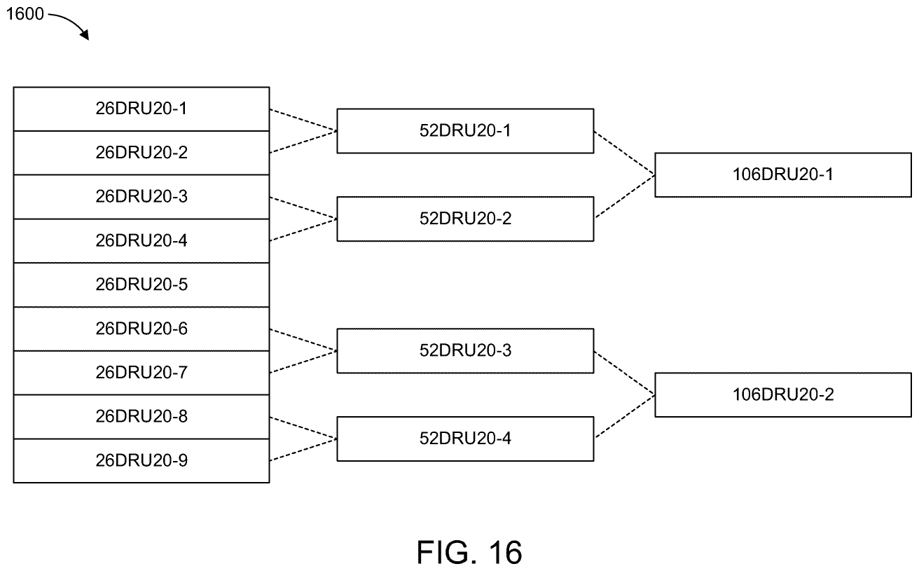

FIG. 16 a resource diagram illustrating an example of combining smaller DRUs to form larger DRUs with the tones of the larger DRUs grouped. As shown in an example in resource diagram 1600, the combination of smaller DRU sizes (e.g., 26DRU or 52 DRU) to form larger DRU sizes (e.g., 52DRU and 106DRU) may be done such that the resulting larger DRU size (e.g., combining two 26DRU20 to form one 52DRU20) consists of groups of tones. The combination of the smaller DRUs may be done such that the tones of two or more smaller DRUs next to each other are combined together in a larger DRU, as illustrated in an example in FIG. 16. By combining the two smaller DRUs next to each other (e.g., 26DRU20-1 and 26DRU20-2) to form the larger DRU (e.g., 52DRU 20-1), the tones of the larger DRU (i.e. 52DRU 20-1) will be grouped together in groups of two tones each.

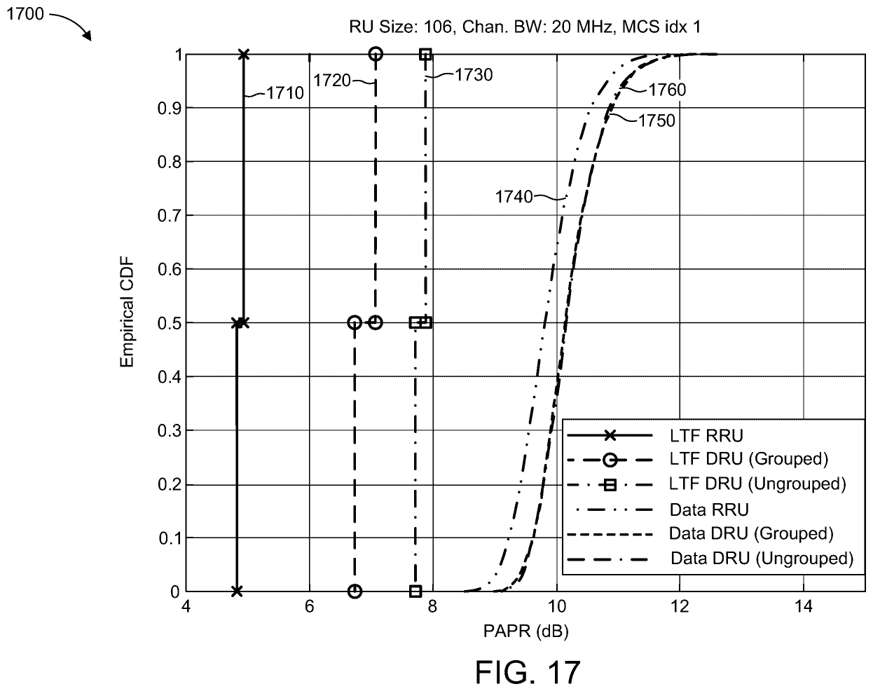

FIG. 17 is a peak-to-average-power ratio (PAPR) performance diagram illustrating an example of the PAPR performance of an LTF of a tone-grouped DRU, an LTF of a tone-ungrouped DRU, and an LTF of an RRU. As shown in an example in PAPR diagram 1700, the method of combining the smaller DRUs may result in a better PAPR performance for the LTF.

In an example shown in FIG. 17, the PAPR of an LTF of a RRU 1710 and data of an RRU 1740 are shown for comparison with the DRUs. Further, the PAPR performance of an LTF of a tone-grouped DRU 1720 is better than the PAPR of an LTF of a tone-ungrouped DRU 1730. Moreover, the PAPR performance of data of a tone-grouped DRU 1750 is better than the PAPR of data of a tone-ungrouped DRU 1760.

In an example, appropriate phase rotation may be applied to the LTF sequence of a given DRU for PAPR reduction. Different values of phase rotation may be applied to different parts of the distribution bandwidth. The values of the phase rotations may be selected to minimize the PAPR for all the combinations of the DRU sizes and distribution bandwidths.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a non-access point (AP) station (STA), the method comprising:
receiving, from an AP, a trigger frame including a resource unit (RU) allocation field indicating a distributed resource unit (DRU) index value;
determining, based on the indicated DRU index value, a distribution bandwidth and a DRU allocation from a plurality of DRU allocations, wherein each of the plurality of DRU allocations includes respective subcarriers; wherein subcarriers of the determined DRU allocation are interleaved with subcarriers of one or more other DRU allocations of the plurality of DRU allocations, across the distribution bandwidth;
determining a DRU long training field (LTF) sequence based on a contiguous subset of values of an extremely high throughput (EHT)-LTF sequence; and
transmitting a signal, to the AP, in the determined DRU allocation, including a physical layer (PHY) preamble including the DRU LTF, wherein each respective value of the DRU LTF sequence is transmitted on a respective subcarrier of the determined DRU allocation.

2. The method of claim 1, wherein the contiguous subset of values is associated with a regular resource unit (RRU) corresponding to the DRU, and wherein one or more other DRU LTFs include a respective plurality of other contiguous subsets of values of the ETH-LTF sequence corresponding to other RRUs.

3. The method of claim 1, wherein the DRU index value is received in a User Info field in the trigger frame.

4. The method of claim 1, wherein the DRU-LTF is determined on a condition of receiving a value in an LTF Method subfield.

5. The method of claim 1, wherein the DRU-LTF is an Ultra High Reliability (UHR) LTF.

6. A non-access point (AP) station (STA) comprising:
a transceiver; and
a processor operatively coupled to the transceiver; wherein:
the transceiver is configured to receive, from an AP, a trigger frame including a resource unit (RU) allocation field indicating a distributed resource unit (DRU) index value;
the processor is configured to determine, based on the indicated DRU index value, a distribution bandwidth and a DRU allocation from a plurality of DRU allocations, wherein each of the plurality of DRU allocations includes respective subcarriers; wherein subcarriers of the determined DRU allocation are interleaved with subcarriers of one or more other DRU allocations of the plurality of DRU allocations, across the distribution bandwidth;
the processor is configured to determine a DRU long training field (LTF) sequence based on a contiguous subset of values of an extremely high throughput (EHT)-LTF sequence; and
the transceiver and the processor are configured to transmit a signal, to the AP, in the determined DRU allocation, including a physical layer (PHY) preamble including the DRU LTF, wherein each respective value of the DRU LTF sequence is transmitted on a respective subcarrier of the determined DRU allocation.

7. The non-AP STA of claim 6, wherein the contiguous subset of values is associated with a regular resource unit (RRU) corresponding to the DRU, and wherein one or more other DRU LTFs include a respective plurality of other contiguous subsets of values of the ETH-LTF sequence corresponding to other RRUs.

8. The non-AP STA of claim 6, wherein the DRU index value is received in a User Info field in the trigger frame.

9. The non-AP STA of claim 6, wherein the DRU-LTF is determined on a condition of receiving a value in an LTF Method subfield.

10. The non-AP STA of claim 6, wherein the DRU-LTF is an Ultra High Reliability (UHR) LTF.

11. A method for use in a non-access point (AP) station (STA), the method comprising:
receiving, from an AP, a trigger frame including a resource unit (RU) allocation field indicating a distributed resource unit (DRU) index value;
determining, based on the indicated DRU index value, a distribution bandwidth and a DRU allocation from a plurality of DRU allocations, wherein each of the plurality of DRU allocations includes respective subcarriers; wherein subcarriers of the determined DRU allocation are interleaved with subcarriers of one or more other DRU allocations of the plurality of DRU allocations, across the distribution bandwidth;
determining a DRU long training field (LTF) sequence based on a subset of values of an extremely high throughput (EHT)-LTF sequence, wherein each respective value of the DRU LTF sequence at a respective subcarrier index is the same as a respective value of the EHT-LTF at the respective subcarrier index; and
transmitting a signal, to the AP, in the determined DRU allocation, including a physical layer (PHY) preamble including the DRU LTF.

12. The method of claim 11, wherein the subset of values of the EHT-LTF is associated with the determined distribution bandwidth.

13. The method of claim 11, wherein the DRU index value is received in a User Info field in the trigger frame.

14. The method of claim 11, wherein the DRU LTF is determined on a condition of receiving a value in an LTF Method subfield.

15. The method of claim 11, wherein the DRU LTF is an Ultra High Reliability (UHR) LTF.

16. A non-access point (AP) station (STA) comprising:
a transceiver; and
a processor operatively coupled to the transceiver; wherein:
the transceiver is configured to receive, from an AP, a trigger frame including a resource unit (RU) allocation field indicating a distributed resource unit (DRU) index value;
the processor is configured to determine, based on the indicated DRU index value, a distribution bandwidth and a DRU allocation from a plurality of DRU allocations, wherein each of the plurality of DRU allocations includes respective subcarriers; wherein subcarriers of the determined DRU allocation are interleaved with subcarriers of one or more other DRU allocations of the plurality of DRU allocations, across the distribution bandwidth;
the processor is configured to determine a DRU long training field (LTF) sequence based on a subset of values of an extremely high throughput (EHT)-LTF sequence, wherein each respective value of the DRU LTF sequence at a respective subcarrier index is the same as a respective value of the EHT-LTF at the respective subcarrier index; and
the transceiver and the processor are configured to transmit a signal, to the AP, in the determined DRU allocation, including a physical layer (PHY) preamble including the DRU LTF, wherein each respective value of the DRU LTF sequence is transmitted on a respective subcarrier of the determined DRU allocation.

17. The non-AP STA of claim 16, wherein the subset of values of the EHT-LTF is associated with the determined distribution bandwidth.

18. The non-AP STA of claim 16, wherein the DRU index value is received in a User Info field in the trigger frame.

19. The non-AP STA of claim 16, wherein the DRU-LTF is determined on a condition of receiving a value in an LTF Method subfield.

20. The non-AP STA of claim 16, wherein the DRU-LTF is an Ultra High Reliability (UHR) LTF.
